(19) United States
(12) Patent Application Publication
(10) Pub. No.: US 2019/0095917 A1
(43) Pub. Date: Mar. 28, 2019

(54) SETTLEMENT APPARATUS, SETTLEMENT SYSTEM, SETTLEMENT METHOD, AND NON-TRANSITORY STORAGE MEDIUM

(71) Applicant: NEC CORPORATION, Tokyo (JP)

(72) Inventor: Takeo OHNO, Tokyo (JP)

(73) Assignee: NEC CORPORATION, Tokyo (JP)

(21) Appl. No.: 16/082,128

(22) PCT Filed: Jan. 11, 2017
(86) PCT No.: PCT/JP2017/000543

§ 371 Date: Sep. 4, 2018

(30) Foreign Application Priority Data
Mar. 10, 2016 (JP) 2016-046519

(51) Int. Cl. G06Q 20/40

(52) U.S. Cl. CPC G06Q 20/405; G06Q 20/4014

(57) ABSTRACT

There is provided a settlement apparatus (10) including a balance information acquisition unit (11) that acquires balance information including a balance of an electronic value and use information of the electronic value from an electronic-value storage unit that stores the balance information; a settlement information acquisition unit (12) that acquires settlement information including an increase or decrease value of the electronic value and the use information; and a settlement unit (13) that executes a settlement process of increasing or decreasing the electronic value stored in the electronic-value storage unit, in a case where the use information included in the balance information and the use information included in the settlement information satisfy a predetermined condition which is set in advance.

### TECHNICAL FIELD

The present invention relates to a settlement apparatus, a settlement system, a settlement method, and a program.

### BACKGROUND ART

Related techniques are disclosed in Patent Documents 1 and 2.

Patent Document 1 discloses a card settlement system which includes a card settlement terminal capable of reading information recorded in a card settlement unit and a computer of a settlement organization allowing settlement using the card settlement unit, which are connected through a communication line, and executes a settlement process of a transaction according to an electronic message transmitted from the card settlement terminal. In this system, a plurality of member store identification codes can be input to the card settlement terminal, so that a plurality of member stores can jointly use the card settlement terminal.

Patent Document 2 discloses a settlement processing apparatus that processes settlement using points. Based on a settlement record including the number of points that a customer uses for settlement, the settlement processing apparatus decreases the number of points of the customer stored in a customer-holding-points storage unit and increases the unpaid amount for a store stored in an unpaid amount information storage unit.

### RELATED DOCUMENT

### Patent Document

[Patent Document 1] Japanese Patent Application Publication No. 2003-108892
[Patent Document 2] Japanese Patent Application Publication No. 2002-117314

### SUMMARY OF THE INVENTION

### Technical Problem

There is a demand for technologies that can limit the use of electronic money. Neither Patent Document 1 nor Patent Document 2 provides relevant technology. The present invention is to provide the technology.

### Solution to Problem

According to the present invention, there is provided a settlement apparatus including a balance information acquisition unit that acquires balance information including a balance of an electronic value and use information of the electronic value from an electronic-value storage unit that stores the balance information; a settlement information acquisition unit that acquires settlement information including an increase or decrease value of the electronic value and the use information; and a settlement unit that executes a settlement process of increasing or decreasing the electronic value stored in the electronic-value storage unit, in a case where the use information included in the balance information and the use information included in the settlement information satisfy a predetermined condition which is set in advance.

Further, according to the present invention, there is provided a settlement system including a storage apparatus including an electronic-value storage unit that stores balance information including a balance of an electronic value and use information of the electronic value; and the settlement apparatus.

Further, according to the present invention, there is provided a settlement method performed by a computer, the method including, a balance information acquisition step of acquiring balance information including a balance of an electronic value and use information of the electronic value from an electronic-value storage unit that stores the balance information; a settlement information acquisition step of acquiring settlement information including an increase or decrease value of the electronic value and the use information; and a settlement step of executing a settlement process of increasing or decreasing the electronic value stored in the electronic-value storage unit, in a case where the use information included in the balance information and the use information included in the settlement information satisfy a predetermined condition which is set in advance.

Further, according to the present invention, there is provided a program causing a computer to function as: a balance information acquisition unit that acquires balance information including a balance of an electronic value and use information of the electronic value from an electronic-value storage unit that stores the balance information; a settlement information acquisition unit that acquires settlement information including an increase or decrease value of the electronic value and the use information; and a settlement unit that executes a settlement process of increasing or decreasing the electronic value stored in the electronic-value storage unit, in a case where the use information included in the balance information and the use information included in the settlement information satisfy a predetermined condition which is set in advance.

### Advantageous Effects of Invention

According to the present invention, the use of electronic money can be restricted.

### BRIEF DESCRIPTION OF THE DRAWINGS

The foregoing and other objects, features and advantages will become more apparent from the following description of preferred example embodiments and the accompanying drawings.

FIG. 1 is a diagram conceptually showing an example of a hardware configuration of an apparatus according to an example embodiment.

FIG. 2 is a diagram for explaining an overview of a settlement system of the present example embodiment.

FIG. 3 is an example of a functional block diagram of a settlement apparatus of the present example embodiment.

FIG. 4 is a diagram for explaining an example of use information of the present example embodiment.

FIG. 5 is a diagram for explaining an example of use information of the present example embodiment.

FIG. 6 is a diagram for explaining an example of use information of the present example embodiment.

FIG. 7 is a diagram schematically showing an example of information processed by a settlement apparatus of the present example embodiment.

FIG. 8 is a diagram schematically showing an example of information processed by a settlement apparatus of the present example embodiment.

FIG. 9 is a flowchart showing an example of a process flow of the settlement apparatus of the present example embodiment.

FIG. 10 is a diagram schematically showing an example of information processed by a settlement apparatus of the present example embodiment.

FIG. 11 is a diagram for explaining an overview of a settlement system of the present example embodiment.

FIG. 12 is a diagram schematically showing an example of information processed by a settlement apparatus of the present example embodiment.

FIG. 13 is a diagram schematically showing an example of information processed by a settlement apparatus of the present example embodiment.

FIG. 14 is a diagram for explaining an application example of the present example embodiment.

FIG. 15 is a diagram for explaining an application example of the present example embodiment.

FIG. 16 is a diagram for explaining an application example of the present example embodiment.

FIG. 17 is a diagram for explaining an application example of the present example embodiment.

### DESCRIPTION OF EMBODIMENTS

First, an example of a hardware configuration of an apparatus (settlement apparatus) of the present example embodiment will be described. Each unit included in the apparatus of the present example embodiment is realized by any combination of hardware and software of any computer, mainly using a central processing unit (CPU), a memory, a program to be loaded into the memory, and a storage unit such as a hard disk storing the program (can store programs stored in advance in the stage of shipping the apparatus, and also store programs downloaded from a storage medium such as a compact disc (CD) or a server on the Internet), and a network connection interface. Those skilled in the art will understand that there are various modifications in the realization methods and apparatuses.

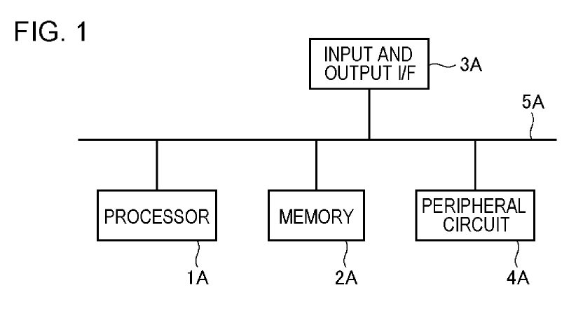

FIG. 1 is a block diagram illustrating a hardware configuration of an apparatus of the present example embodiment. As shown in FIG. 1, the apparatus includes a processor 1A, a memory 2A, an input and output interface 3A, a peripheral circuit 4A, and a bus 5A. The peripheral circuit includes various modules.

The bus 5A is a data transmission path through which the processor 1A, the memory 2A, the peripheral circuit 4A and the input and output interface 3A mutually transmit and receive data. The processor 1A is, for example, an arithmetic processing apparatus such as a central processing unit (CPU) or a graphics processing unit (GPU). The memory 2A is, for example, a memory such as a random access memory (RAM) or a read only memory (ROM). The input and output interface 3A includes an interface for acquiring information from an external apparatus, an external server, an external sensor, or the like. The processor 1A issues commands to the respective modules and performs calculations based on the calculation results.

Hereinafter, the present example embodiment will be described. Note that, the functional block diagram used in the description of the following exemplary example embodiment shows blocks of functional units rather than a configuration of a hardware unit. These drawings show that each apparatus is realized by a single apparatus, but means of realizing each apparatus is not limited to this. That is, it may be a physically separated configuration or a logically divided configuration. Note that, the same reference numerals may be attached to the same configuration components, and the description thereof will not be repeated as appropriate.

### First Example Embodiment

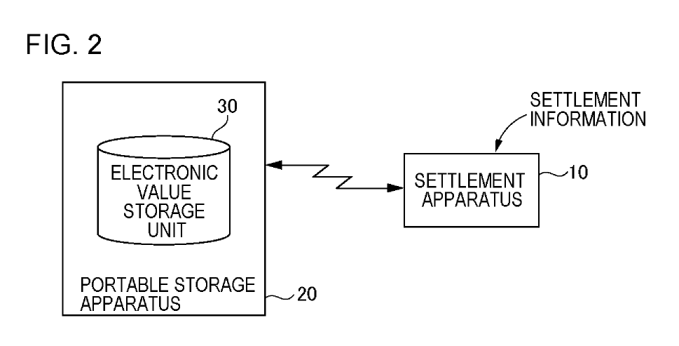

An overview of a settlement system of the present example embodiment will be described with reference to FIG. 2. In the present example embodiment, a settlement process can be performed using a settlement apparatus 10 and a portable storage apparatus 20.

The settlement apparatus 10 is an apparatus used for a settlement process, and is installed in a store or the like. The portable storage apparatus 20 is a portable storage apparatus, and is held by a customer. As the portable storage apparatus 20, for example, an electronic card, a smartphone, a tablet, a mobile phone, an electronic tag, or the like is conceivable, but the portable storage apparatus 20 is not limited thereto.

The settlement apparatus 10 and the portable storage apparatus 20 have a function of communicating with each other under a predetermined communication standard. For example, the settlement apparatus 10 and the portable storage apparatus 20 may perform communication when the positional relationship between them satisfies a predetermined condition (for example, short-range wireless communication), may perform communication when they contact each other, and may perform communication when they are mutually connected by wires. Communication standards are not particularly limited, and any communication standard can be adopted.

The electronic-value storage unit 30 of the portable storage apparatus 20 stores balance information. The balance information includes the balance of the electronic value (electronic money) and use information indicating the use of the electronic value. Each electronic value is restricted to use indicated by associated use information. Note that, the electronic-value storage unit 30 may store a plurality of pairs in which the balance of the electronic value and the use information are paired.

Settlement information is input to the settlement apparatus 10. The settlement information includes a settlement amount and information (use information) indicating the electronic value that can be used in the settlement.

The settlement amount is calculated by inputting a product to be settled (a product to be purchased, a product to be sold) to a predetermined apparatus. For example, the predetermined apparatus is a product registration apparatus (for example, a point of sales (POS) register) for settlement process, and a product to be settled for is registered by reading a product code as well as by operation of a touch panel display or an input button provided in the register. Thereafter, settlement amounts (total purchase amount, total sales amount) are calculated by totaling the amounts of registered products.

The information indicating the electronic value that can be used in the settlement is the use information associated with the electronic value. For example, the electronic value that can be used in each store may be determined. In addition, the electronic value that can be used for each product may be determined.

The settlement apparatus 10 acquires balance information from the electronic-value storage unit 30 of the portable storage apparatus 20. Then, the settlement apparatus 10 executes a settlement process using the electronic value stored in the electronic-value storage unit 30, in a case where the use information included in the balance information and the use information included in the settlement information satisfy a predetermined condition which is set in advance. Specifically, the balance of the electronic value stored in the electronic-value storage unit 30 is reduced by a predetermined amount (for example, settlement amount). Then, the electronic value of the store stored in a predetermined storage apparatus is increased by a predetermined amount (for example, settlement amount).

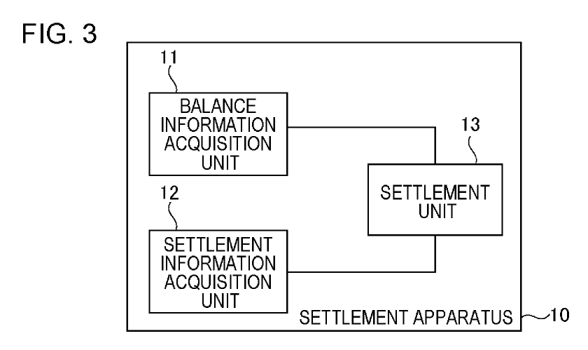

Hereinafter, the configuration of the settlement apparatus 10 of the present example embodiment will be described in detail. FIG. 3 shows an example of a functional block diagram of the settlement apparatus 10. As shown in FIG. 3, the settlement apparatus 10 includes a balance information acquisition unit 11, a settlement information acquisition unit 12, and a settlement unit 13.

The balance information acquisition unit 11 acquires balance information, from the electronic-value storage unit 30 that stores balance information including balance of the electronic value and use information of the electronic value indicating the use of the electronic value. The balance information acquisition unit 11 can acquire the balance information of the customer who makes the payment.

The value of the use information can be a code value. That is, in the electronic-value storage unit 30, a code value is stored as use information. In the present example embodiment, “color” is used as a code value for ease of imaging, but it is only an example, and it is not limited thereto.

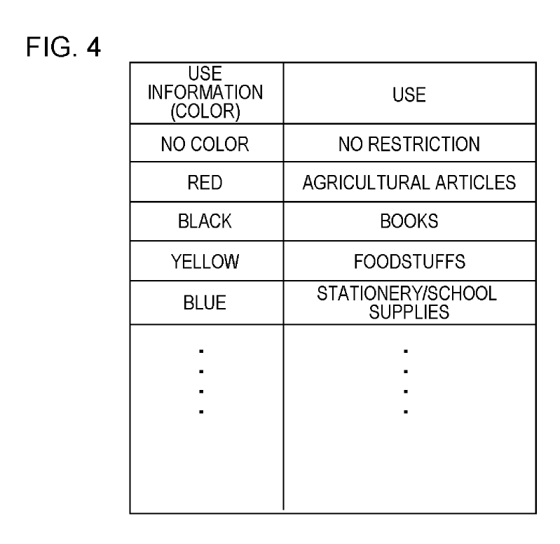

FIG. 4 shows an example of the use information of the present example embodiment expressed by the code value. As shown in FIG. 4, each color (code value) corresponds to the use of electronic value.

In the case of the illustrated example, the electronic value associated with the use information “no color” can be used with no restriction on use. The electronic value associated with the use information “red” is restricted to use in purchasing agricultural articles. The electronic value associated with the use information “black” is restricted to use in purchasing books. The electronic value associated with the use information “yellow” is restricted to use in purchasing foodstuffs. The electronic value associated with the use information “blue” is restricted to use in purchasing stationery and school supplies.

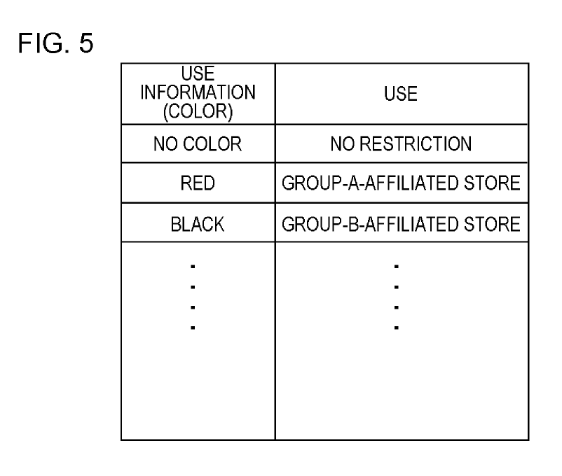

It should be noted that, the above-described example of limiting the use in purchasing products is merely an example, and other examples are also conceivable. For example, the use may be restricted to available stores. An example of this case is shown in FIG. 5. The electronic value associated with the use information “no color” can be used at any store. The electronic value associated with the use information “red” is restricted to the use at the stores affiliated to the A group. The electronic value associated with the use information “black” is restricted to the use at the stores affiliated to the B group. Although not shown, in the case of this example, the following contents may be registered. For example, the electronic value associated with the use information “yellow” is restricted to use in a department store. The electronic value associated with the use information “blue” is restricted to use at a store joining a predetermined event. The electronic value associated with the use information “green” is restricted to use in book stores.

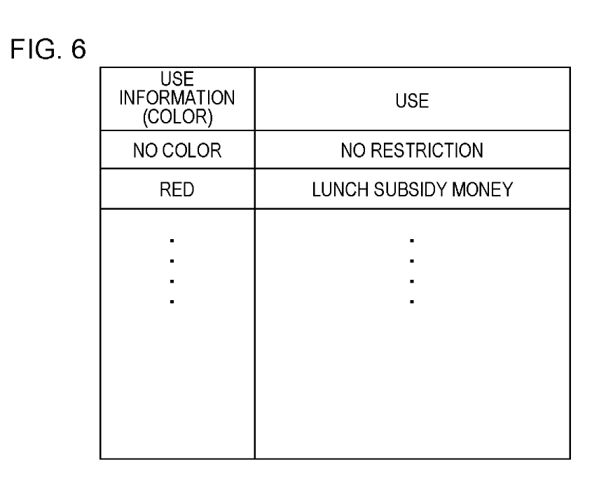

As another example, an example is conceivable in which the company provides employees with electronic money with limited use. An example of this case is shown in FIG. 6. The electronic value associated with the use information “no color” can be used for any purpose. The electronic value associated with the use information “red” is an electronic value provided to subsidize lunch, and is restricted to use in a predetermined restaurant (for example, a cafeteria) or to purchase foodstuffs. Although not shown, in the case of this example, the following contents may be registered. For example, the electronic value associated with the use information “yellow” is an electronic value provided to subsidize transportation expenses, and is restricted to use such as public transportation, taxi, or the like.

The balance information acquisition unit 11 of the present example embodiment acquires balance information including the balance of the electronic value (for example, 9800) and use information (for example, red), from the identification information storage unit 21 of the portable storage apparatus 20 that can communicate with the settlement apparatus 10 (for example, connection by contact, wire, or the like in which the positional relationship between them satisfies a predetermined condition).

Returning to FIG. 3, the settlement information acquisition unit 12 acquires settlement information including an increase or decrease value of the electronic value and the use information.

First, a unit that acquires an increase or decrease value of an electronic value will be described. For example, the settlement information acquisition unit 12 may acquire the above-described settlement amount as the increase or decrease value of the electronic value from the above-described product registration apparatus. At this time, the settlement information acquisition unit 12 may further acquire information for identifying a product to be settled from the product registration apparatus.

It should be noted that, the settlement apparatus 10 and the product registration apparatus may be physically and/or logically separated, or may be integrated physically and/or logically. In the case where the settlement apparatus 10 and the product registration apparatus are physically and/or logically separated, they are connected by wired and/or wireless, and are in a state where information can be transmitted and received.

In addition, the settlement information acquisition unit 12 may be provided with an input unit (for example, an operation button, a touch panel display, a microphone, or the like) that inputs the above-described settlement amount. Then, by the operation by the clerk through the input unit, the input of the above-described settlement amount may be received. The settlement information acquisition unit 12 may acquire the settlement amount of which the input is received in this way as the increase or decrease value of the electronic value.

Next, in the settlement information acquisition unit 12, a unit that acquires information (use information) indicating the electronic value usable in the settlement will be described.

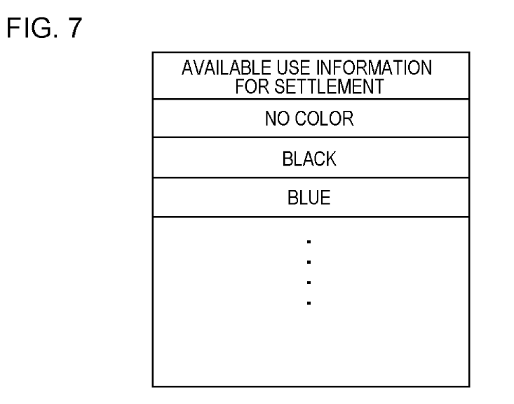

For example, the electronic value that can be used in each store may be determined. In this case, the use information as shown in FIG. 7 is stored in advance in the settlement apparatus 10 or the apparatus communicably connected with the settlement apparatus 10. The settlement information acquisition unit 12 acquires the use information as settlement information.

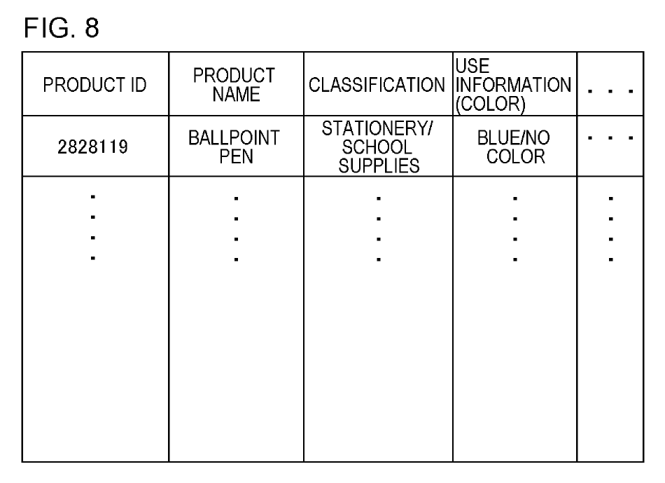

In addition, the electronic value that can be used for each product may be determined. In this case, the product information as shown in FIG. 8 is stored in the settlement apparatus 10 or the apparatus communicably connected with the settlement apparatus 10. The product information is information on products handled in each store, and a product identifier (ID), a product name, a classification, and use information corresponding to each classification are associated with each other. In the settlement of each product, it is possible to use an electronic value associated with the use information corresponding to each product. In the case of the illustrated example, it means that the electronic value associated with the use information “blue” and the electronic value associated with the use information “no color” can be used in the settlement of the ballpoint pen with the product ID “2828119”.

When acquiring information (product ID or the like) for identifying a product to be settled from the product registration apparatus, the settlement information acquisition unit 12 acquires the use information corresponding to the information from the product information as shown in FIG. 8. In a case where there are a plurality of products to be settled, use information can be acquired for each product.

Returning to FIG. 3, in a case where the use information included in the balance information acquired by the balance information acquisition unit 11 and the use information included in the settlement information acquired by the settlement information acquisition unit 12 satisfy a predetermined condition which is set in advance, the settlement unit 13 executes a settlement process for increasing or decreasing the electronic value stored in the electronic-value storage unit 30. The settlement unit 13 may further execute a process of adding the amount reduced from the customer's electronic value to the electronic value of the store, as the settlement process. The electronic value of the store is stored in the storage apparatus in the settlement apparatus 10 or the apparatus communicably connected with the settlement apparatus 10.

Through the above two processes, the electronic value for the reduced amount is transferred from the customer's electronic value to the store's electronic value. When transferring the electronic value of the customer to the electronic value of the store, the settlement unit 13 may be able to change the content of the use information of the electronic value. For example, in the settlement process, the settlement unit 13 may reduce the electronic value of the use information “red” of the customer by a predetermined amount and increase the electronic value of the use information “no color” of the store by the predetermined amount. Thus, the use information of the electronic value for the transferred amount is changed from “red” to “no color”.

It should be noted that this example exemplifies a process in which the settlement unit 13 increases the electronic value of the use information “no color” of the store by the predetermined amount, but it is merely an example. The settlement unit 13 may increase the electronic value of other use information (other than no color, for example, red, blue, or the like) of the store by the predetermined amount. The other use information may be the same use information as the use information of the customer's electronic value reduced by a predetermined amount in the settlement process or may be different use information.

The “predetermined condition” is, for example, “a case where the use information included in the customer's balance information matches the use information included in the settlement information”.

It should be noted that, in a case where the settlement information acquisition unit 12 acquires the use information corresponding to each product to be settled, the settlement unit 13 may determine whether the predetermined condition is satisfied for each product, that is, whether or not settlement is possible with the electronic value stored in the electronic-value storage unit 30. Then, only products that can be settled for may be settled for. In this case, the settlement unit 13 can acquire information (such as a unit price) of the product from, for example, product master data stored in a predetermined storage apparatus, and calculate the sum of settlement amounts of the products that can be settled. Then, the calculated total is subtracted from the customer's electronic value, and the total is added to the electronic value of the store. Further, the settlement unit 13 may calculate the sum of the settlement amounts of the products that cannot be settled with the electronic value, and may output the sum as the unsettled amount on the display or the like.

Here, an example of a process in which the electronic value is loaded on the portable storage apparatus 20 will be described. For example, it is possible to load the electronic value on the portable storage apparatus 20 using a predetermined load terminal. The load terminal and the settlement apparatus 10 may be the same terminal or may be different terminals.

For example, the load terminal may be installed in a predetermined store and designed to be operated by a clerk. In this case, the owner of the portable storage apparatus 20 pays a predetermined amount of money at the store and requests the store to load the electronic value corresponding thereto. At this time, a request to associate the use information with the electronic value to be loaded can also be made. The clerk operates the load terminal to input the load amount and use information associated with the electronic value to be loaded. Thereafter, when the load terminal and the portable storage apparatus 20 are communicable with each other, they communicate with each other, and the balance information stored in the electronic-value storage unit 30 of the portable storage apparatus 20 is updated. For example, the load terminal and the portable storage apparatus 20 may perform communication when the positional relationship between them satisfies a predetermined condition (for example, short-range wireless communication), may perform communication when they contact each other, and may perform communication when they are mutually connected by wires. Communication standards are not particularly limited, and any communication standard can be adopted.

As another example, the load terminal may be designed to be operated by the customer himself or herself. In this case, the owner of the portable storage apparatus 20 inputs a predetermined amount of money to the load terminal and requests to load a predetermined amount of electronic value. At this time, an input for associating the use information with the electronic value to be loaded can also be performed. Thereafter, when the load terminal and the portable storage apparatus 20 are communicable with each other, they communicate with each other, and the balance information stored in the electronic-value storage unit 30 of the portable storage apparatus 20 is updated.

As another example, there may be an online account for electronic value. In the online account, the balance information including the balance of the electronic value and use information indicating the use of the electronic value are stored. Then, an electronic value may be added to an account or an electronic value may be transferred between accounts, through a personal computer (PC), a smartphone, a dedicated terminal or the like. When an electronic value is added to an account or when an electronic value is transferred between accounts, the requestor of the operation may be able to input an instruction to associate the use information with the electronic value to be added or transferred. According to the input, use information is associated with the electronic value.

Then, the owner of the portable storage apparatus 20 may operate the load terminal to input identification information of his or her online account, and perform an input of transferring a predetermined amount of the electronic value in the account to the portable storage apparatus 20. Thereafter, when the load terminal and the portable storage apparatus 20 are communicable with each other, they communicate with each other, and the balance information stored in the electronic-value storage unit 30 of the portable storage apparatus 20 is updated.

It should be noted that, when predetermined conditions are satisfied, use information of the electronic value stored in the online account or the portable storage apparatus 20 may be automatically changed to predetermined contents. For example, when the balance of the electronic value reaches a predetermined amount (predetermined condition), the use information associated at that time may be changed to another use information (for example, change from blue to gold).

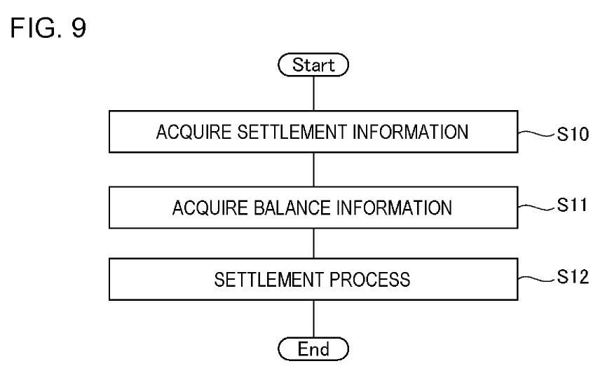

Next, an example of the process flow of the present example embodiment will be described with reference to the flowchart of FIG. 9.

The settlement information acquisition unit 12 acquires settlement information including an increase or decrease value (example, settlement amount) of the electronic value and use information (S10). The use information may be use information set in advance for each store, or may be use information set in advance for products to be settled.

Thereafter, the balance information acquisition unit 11 acquires customer's balance information, from the electronic-value storage unit 30 (portable storage apparatus 20) that stores balance information including the balance of the electronic value and use information indicating use of the electronic value (S11).

Thereafter, in a case where the use information included in the customer's balance information and the use information included in the settlement information satisfy a predetermined condition which is set in advance, the settlement unit 13 performs a predetermined settlement process (S12). Specifically, the settlement unit 13 subtracts a predetermined amount (for example, settlement amount) from the customer's electronic value stored in the electronic-value storage unit 30. Further, the settlement unit 13 adds a predetermined amount (for example, settlement amount) to the electronic value of the store stored in the predetermined storage unit.

According to the present example embodiment described above, the electronic value can be restricted in use. For example, a company that provides an electronic value to employees for the purpose of lunch subsidization and transportation expenses subsidization can provide the employee with the electronic value associated with the corresponding use information with any of the above-described means. By doing this, it is possible to prevent the provided electronic value from being used for other purposes.

In addition, for example, parents can provide pocket money to children with an electronic value associated with appropriate use information such as books, foodstuffs, stationery and school supplies and the like. This makes it possible to suppress inconvenience that children use pocket money for unfavorable uses.

For example, a community, which wishes to increase the number of shoppers in the area for the purpose of local revitalization or the like, can give as a present or sell at a low price an electronic value associated with use information restricted for use at stores in the area to the shopper. Thus, it is possible to suppress the inconvenience that the electronic value provided to the shopper is used outside the area.

In addition, a person who gives a loan to a certain object can provide the borrower with an electronic value associated with use information (for example, agriculture supplies) suitable for the purpose of loan. Thus, it is possible to suppress the inconvenience that the loaned electronic value is used for purposes other than for the purpose of loan.

Further, according to the present example embodiment, the use information can be expressed in color. In such a case, the user of an electronic value can recognize the use of the electronic value possessed by the user, an electronic value that can be used for shopping at each store, or the like from color. Therefore, it is possible to intuitively recognize an attribute of electronic value and availability at each store.

### Second Example Embodiment

The present example embodiment is different from the first example embodiment in that the electronic value can be given an expiration date. Other configurations are the same as those in the first example embodiment.

FIG. 3 shows an example of a functional block diagram of the settlement apparatus 10 of the present example embodiment. As shown in FIG. 3, the settlement apparatus 10 includes a balance information acquisition unit 11, a settlement information acquisition unit 12, and a settlement unit 13. The configuration of the settlement information acquisition unit 12 is the same as that of the first example embodiment.

The balance information acquisition unit 11 further acquires the expiration date of the electronic value as the customer balance information. The settlement unit 13 performs the above-described settlement process using the electronic value that has not passed the expiration date. Note that, when transferring the electronic value with the expiration date of the customer to the electronic value of the store, the settlement unit 13 may be able to cancel the expiration date of the electronic value. For example, in the settlement process, the settlement unit 13 may reduce the electronic value with the expiration date of the customer by a predetermined amount and increase the electronic value without the expiration date of the store by the predetermined amount. Other configurations of the balance information acquisition unit 11 and the settlement unit 13 are the same as those in the first example embodiment.

The method of associating the expiration date with the electronic value can be implemented in the same manner as the method of associating the use information with the electronic value.

According to the present example embodiment described above, the same advantageous effects as those of the first example embodiment can be realized. Further, according to the present example embodiment, it is possible to add an expiration date of the electronic value. Therefore, it is possible to suppress inconvenience of hoarding the electronic value without using it.

For example, a community, which wishes to increase the number of shoppers in the area for the purpose of local revitalization or the like, can give as a present or sell at a low price an electronic value associated with use information restricted for use at stores in the area and an expiration date to the shopper. In such a case, it is possible to suppress inconveniences in which the electronic value provided to the shopper is used outside the area, and to suppress inconvenience that the electronic value is not readily used.

In addition, a person who gives a loan to a certain object can provide the borrower with an electronic value associated with use information (for example, agriculture supplies) suitable for the purpose of loan and expiration date. In such a case, it is possible to suppress inconvenience that the loaned electronic value is used for purposes other than the purpose of loan, or the inconvenience of hoarding the electronic value without using it.

### Third Example Embodiment

The present example embodiment is different from the first and second example embodiments in that plural electronic values associated with different pieces of use information are acquired, and if there are plural available electronic values among them, the settlement apparatus 10 determines an electronic value to be used for a settlement process according to a predetermined priority order. Other configurations are the same as those in the first and second example embodiments.

FIG. 3 shows an example of a functional block diagram of the settlement apparatus 10 of the present example embodiment. As shown in FIG. 3, the settlement apparatus 10 includes a balance information acquisition unit 11, a settlement information acquisition unit 12, and a settlement unit 13. The configuration of the settlement information acquisition unit 12 is the same as those of the first and second example embodiments.

The balance information acquisition unit 11 acquires a plurality of electronic values associated with different types of use information, from the electronic-value storage unit 30 (portable storage apparatus 20). For example, the balance information acquisition unit 11 acquires a pair of the balance “9800” of the electronic value and the use information “red” and a pair of the balance “4500” of the electronic value and the use information “no color”.

In a case where there are a plurality of pairs satisfying the above-described predetermined condition (in a case where there are a plurality of electronic values available for settlement), the settlement unit 13 determines the electronic value to be used for the settlement process, based on a priority which is set in advance.

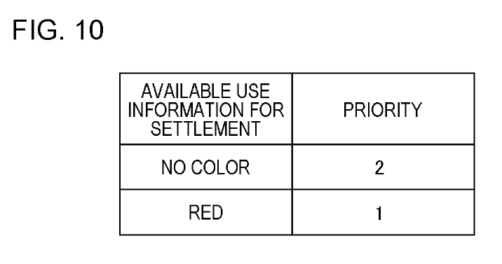

For example, in the case where the electronic value usable for each store is determined, the use information as shown in FIG. 10 is stored in the settlement apparatus 10 or the apparatus communicably connected with the settlement apparatus 10. In the use information, a list of settlement information usable at the store is recorded, and priority is associated with each settlement information. According to the information shown in FIG. 10, it is shown that the electronic value associated with the use information “no color” and the electronic value associated with the use information “red” can be used for settlement in the store. In a case where the customer has these two electronic values, it can be seen that settlement is performed by preferentially using the electronic value associated with the use information “red”. Note that, when electronic value that can be used is determined for each product, the process can be performed in the same manner as above.

According to the present example embodiment described above, the same advantageous effects as those of the first and second example embodiments can be realized. Further, for example, a company that provides an electronic value to employees for the purpose of lunch subsidization can set the settlement apparatus 10 installed in the cafeteria in the company (set the above priority order) to preferentially use the electronic value associated with the corresponding use information in the settlement process. As a result, favorable electronic value for customers can be used preferentially, which improves customer convenience.

### Fourth Example Embodiment

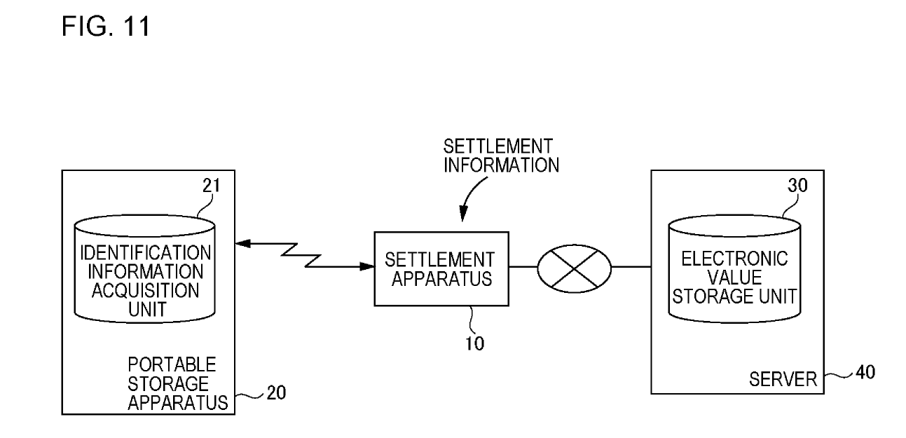

An overview of a settlement system of the present example embodiment will be described with reference to FIG. 11. In the present example embodiment, a settlement process can be performed using a settlement apparatus 10, a portable storage apparatus 20, and a server 40. The settlement apparatus 10 and the server 40 are connected to a network such as the Internet, and information can be mutually transmitted and received therebetween.

The settlement apparatus 10 is an apparatus used for a settlement process, and is installed in a store or the like. The portable storage apparatus 20 is a portable storage apparatus, and is held by a customer. As the portable storage apparatus 20, for example, an electronic card, a smartphone, a tablet, a mobile phone, an electronic tag, or the like is conceivable, but the portable storage apparatus 20 is not limited thereto.

The settlement apparatus 10 and the portable storage apparatus 20 have a function of communicating with each other under a predetermined communication standard. For example, the settlement apparatus 10 and the portable storage apparatus 20 may perform communication when the positional relationship between them satisfies a predetermined condition (for example, short-range wireless communication), may perform communication when they contact each other, and may perform communication when they are mutually connected by wires. Communication standards are not particularly limited, and any communication standard can be adopted.

The identification information storage unit 21 of the portable storage apparatus 20 stores identification information (customer identification information) corresponding to the portable storage apparatus 20 or each customer.

In the present example embodiment, the server 40 includes an electronic-value storage unit 30. The electronic-value storage unit 30 stores balance information including the balance of the electronic value and use information. The balance information is associated with customer identification information.

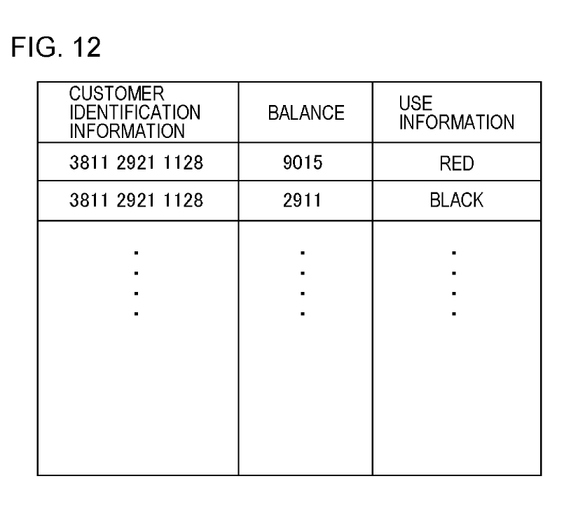

FIG. 12 shows an example of information stored in the electronic-value storage unit 30. In the illustrated example, customer identification information, balance (balance of electronic value), and use information are associated with each other. Note that, in association with one customer identification information, a pair of balance and use information may be registered or a plurality of pairs may be registered.

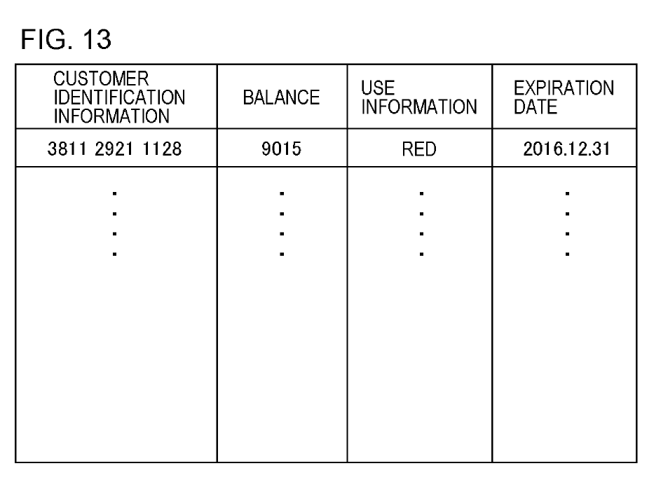

FIG. 13 shows another example of the information stored in the electronic-value storage unit 30. The illustrated example is different from the information shown in FIG. 12 in that the expiration date is further associated with the electronic value.

An example of the functional block diagram of the settlement apparatus 10 is shown in FIG. 3. As shown in FIG. 3, the settlement apparatus 10 includes a balance information acquisition unit 11, a settlement information acquisition unit 12, and a settlement unit 13. The configuration of the settlement information acquisition unit 12 is the same as those of the first to third example embodiments.

The balance information acquisition unit 11 acquires customer identification information from the identification information storage unit 21 of the portable storage apparatus 20. Then, the balance information acquisition unit 11 requests the server 40 for balance information corresponding to the customer identification information. In response to the request, the server 40 searches the electronic-value storage unit 30 and acquires balance information corresponding to the acquired customer identification information. Thereafter, the server 40 returns the acquired balance information to the settlement apparatus 10. The balance information acquisition unit 11 acquires the balance information returned from the settlement apparatus 10 in this way.

In a case where the use information included in the customer's balance information and the use information included in the settlement information satisfy a predetermined condition which is set in advance, the settlement unit 13 requests the server 40 to update the customer's balance information. Specifically, the settlement unit 13 transmits an update request including customer identification information, a reduction value, and information determining the electronic value to be reduced (for example, associated use information) to the server 40. This is a request to reduce the predetermined electronic value corresponding to the customer identification information by a reduction value.

It should be noted that, the electronic-value storage unit 30 of the server 40 may store balance information of the electronic value of the store. Then, in a case where the use information included in the customer's balance information and the use information included in the settlement information satisfy a predetermined condition which is set in advance, the settlement unit 13 may request the server 40 to update the store's balance information. Specifically, the settlement unit 13 transmits an update request including the customer identification information corresponding to the store, the increase value, and information determining the electronic value to be increased (for example, associated use information) to the server 40. This is a request to increase the predetermined electronic value corresponding to the customer identification information by the increase value.

As a modification example of the present example embodiment, it is possible to replace the portable storage apparatus 20 with a printed matter on which a code indicating customer identification information (for example, one-dimensional code, two-dimensional code, or the like) is printed. Then, the settlement apparatus 10 can be provided with a code reader that reads the code. The balance information acquisition unit 11 acquires the customer identification information read by the code reader and executes the same process as described above. Other configurations of the modification example are the same as those described above. Note that, a technique using the portable storage apparatus 20 and a technique using the printed matter may be used in combination.

According to the present example embodiment described above, the same advantageous effects as those of the first to third example embodiments can be realized. Further, the server 40 can manage the balance information of the customer. Therefore, it is possible to suppress inconvenience such as improper rewriting of balance information.

### Application Example 1

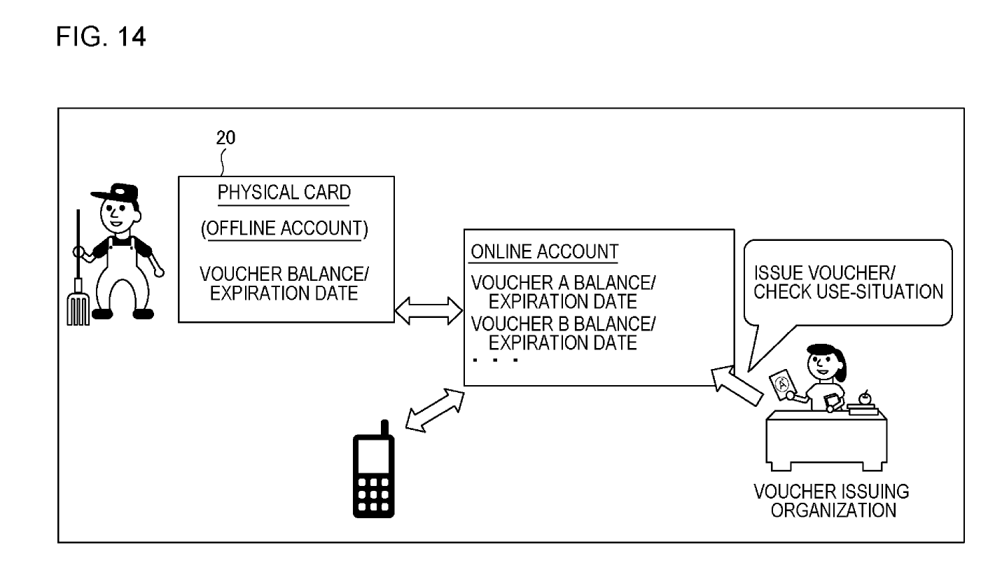

An application example of the above-described example embodiment will be described with reference to FIG. 14. The voucher issuing organization provides an electronic value with an expiration date to a predetermined user. Specifically, an electronic value with an expiration date is credited to the online account of the user. At this time, the use information may further be associated.

There are a plurality of electronic values provided by the voucher issuing organization in the user's online account. Electronic values with expiration dates different from one other and electronic values provided from voucher issuing organizations different from one other are managed as electronic values different from one other.

The user operates a predetermined load terminal to transfer the electronic value existing in his or her online account to a predetermined physical card (portable storage apparatus 20). One physical card (portable storage apparatus 20) may be able to store the balance information of a plurality of electronic values (electronic values with different expiration dates, voucher issuing organizations, or the like), or one physical card (portable storage apparatus 20) may be able to store the balance information of one electronic value.

The user makes payment at a predetermined store using the physical card (the portable storage apparatus 20).

### Application Example 2

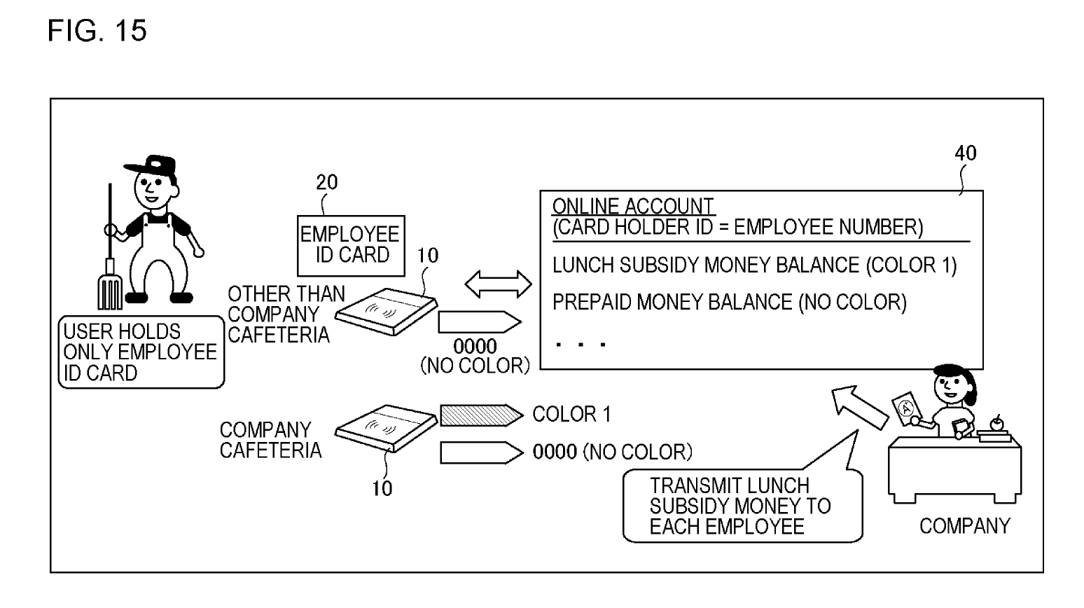

Another application example of the above-described example embodiment will be described with reference to FIG. 15. The company provides employees with an electronic value for the purpose of lunch subsidization. Specifically, an electronic value corresponding to use information (color 1) for lunch subsidization is credited to the online account of each employee. The online account is managed by the server 40 (see FIG. 11) described in the fourth example embodiment.

As shown in FIG. 15, there is an electronic value associated with other use information (no color) in addition to the electronic value associated with the use information (color 1), in the online account of the employee shown. The electronic value associated with the use information (no color) is an electronic value that can be used without restriction of use.

The employee makes payment at the cafeteria using an electronic employee ID card (portable storage apparatus 20) that stores customer identification information. Specifically, the settlement apparatus 10 installed in the cafeteria acquires customer identification information from the employee ID card. Then, as described in the fourth example embodiment, the online account (server 40) is accessed and settlement process is performed.

In a cafeteria other than the company cafeteria, it is possible to use only the electronic value associated with the use information (no color). For this reason, the settlement apparatus 10 installed in the cafeteria performs the settlement process using the electronic value associated with the use information (no color).

On the other hand, in the company cafeteria, it is possible to use the electronic value associated with the use information (no color) and the electronic value associated with the use information (color 1). Then, the electronic value associated with the use information (color 1) has a higher priority. Therefore, the settlement apparatus 10 installed in the company cafeteria preferentially uses the electronic value associated with the use information (color 1) to perform the settlement process. Note that, in a case where the balance of the electronic value associated with the use information (color 1) is less than the settlement amount, the shortage may be reduced from the electronic value associated with the use information (no color).

### Application Example 3

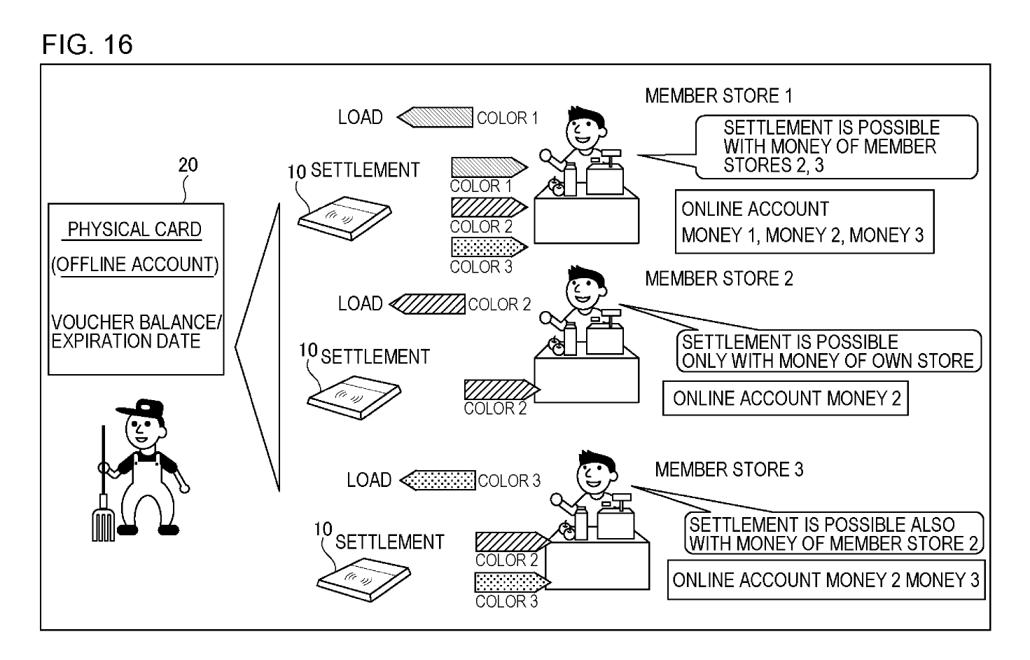

Another application example of the above-described example embodiment will be described with reference to FIG. 16. The electronic value associated with the use information (color 1) is an electronic value of which issuance is managed by the member store 1, and can be loaded only at the member store 1. The electronic value associated with the use information (color 2) is an electronic value of which issuance is managed by the member store 2, and can be loaded only at the member store 2. The electronic value associated with the use information (color 3) is an electronic value of which issuance is managed by the member store 3, and can be loaded only at the member store 3.

In the present application example, each member store can determine the electronic value that can be used for the settlement process in each member store. Therefore, as shown in FIG. 16, the electronic values that can be used for the settlement process for respective member stores are different.

The member store 1 can use an electronic value associated with use information (color 1, color 2, color 3) for the settlement process. The member store 2 can use the electronic value associated with the use information (color 2) for the settlement process. The member store 3 can use the electronic value associated with the use information (color 2, color 3) for the settlement process.

In the present application example, each member store may set and change the electronic value that can be used in a settlement process. Each member store can determine the electronic value that can be used based on the management policy of the store and set the electronic value in the settlement apparatus 10. This increases the degree of freedom in sales styles of member stores.

### Application Example 4

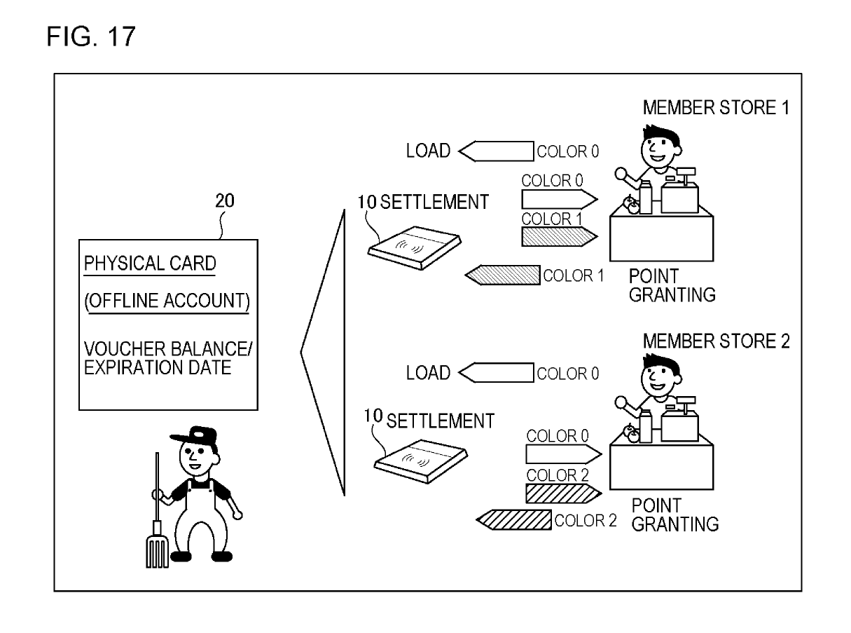

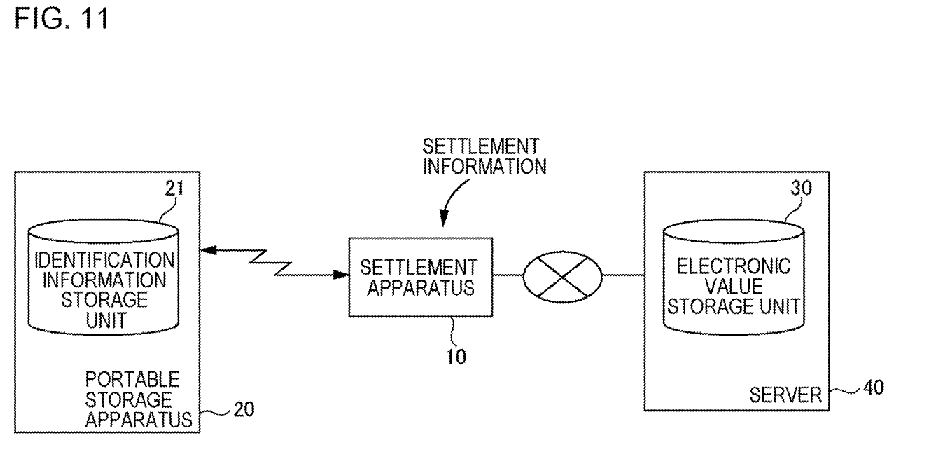

Another application example of the above-described example embodiment will be described with reference to FIG. 17. In the present application example, the electronic value of the present example embodiment is used for a service of granting a point depending on the payment amount. That is, the electronic value of the present example embodiment is provided to the customer according to the payment amount. At this time, the electronic value is provided to the customer, together with use information for only use at its own store.

In FIG. 17, the member store 1 provides the customer with the electronic value associated with the use information (color 1) allowing use only at its own store, according to the payment amount. The member store 2 provides the customer with the electronic value associated with the use information (color 2) allowing use only at its own store, according to the payment amount.

Examples of a reference aspect will be added below.

1. A settlement apparatus including:

a balance information acquisition unit that acquires balance information including balance of an electronic value and use information of the electronic value from an electronic-value storage unit that stores the balance information;

a settlement information acquisition unit that acquires settlement information including an increase or decrease value of the electronic value and the use information; and

a settlement unit that executes a settlement process of increasing or decreasing the electronic value stored in the electronic-value storage unit, in a case where the use information included in the balance information and the use information included in the settlement information satisfy a predetermined condition which is set in advance.

2. The settlement apparatus according to 1,

wherein the balance information acquisition unit receives the balance information, from a portable storage apparatus including the electronic-value storage unit.

3. The settlement apparatus according to 2,

wherein a server includes the electronic-value storage unit, and the balance information stored in the electronic-value storage unit is associated with customer identification information, and

wherein when acquiring the customer identification information, the balance information acquisition unit acquires the balance information associated with the customer identification information from the electronic-value storage unit.

4. The settlement apparatus according to any one of 1 to 3,

wherein the settlement unit further executes a process of adding an amount reduced from the electronic value of a customer to the electronic value of a store, as the settlement process.

5. The settlement apparatus according to 4,

wherein the settlement unit changes content of the use information of the electronic value when the electronic value of the customer is transferred to the electronic value of the store.

6. The settlement apparatus according to any one of 1 to 5,

wherein the settlement information acquisition unit acquires the use information which is set in advance for each store, as the settlement information.

7. The settlement apparatus according to any one of 1 to 5,

wherein the settlement information acquisition unit acquires the use information which is set in advance for a product to be settled for, as the settlement information.

8. The settlement apparatus according to any one of 1 to 7,

wherein the electronic-value storage unit further stores an expiration date of the electronic value, as the balance information, and

wherein the settlement unit performs the settlement process using the electronic value of which the expiration date has not passed.

9. The settlement apparatus according to any one of 1 to 8,

wherein the balance information acquisition unit acquires a plurality of pairs each having the balance of the electronic value and the use information, and

wherein in a case where there are a plurality of pairs satisfying the predetermined condition, the settlement unit determines the electronic value to be used for the settlement process, based on a priority which is set in advance.

10. A settlement system including:

a storage apparatus including an electronic-value storage unit that stores balance information including a balance of an electronic value and use information of the electronic value; and

the settlement apparatus according to any one of 1 to 9,

11. A settlement method performed by a computer, the method including:

a balance information acquisition step of acquiring balance information including a balance of an electronic value and use information of the electronic value from an electronic-value storage unit that stores the balance information;

a settlement information acquisition step of acquiring settlement information including an increase or decrease value of the electronic value and the use information; and

a settlement step of executing a settlement process of increasing or decreasing the electronic value stored in the electronic-value storage unit, in a case where the use information included in the balance information and the use information included in the settlement information satisfy a predetermined condition which is set in advance.

11-2. The settlement method according to 11,

wherein in the balance information acquisition step, the balance information is received from a portable storage apparatus including the electronic-value storage unit.

11-3. The settlement method according to 11-2,

wherein the server includes the electronic-value storage unit, and the balance information stored in the electronic-value storage unit is associated with customer identification information, and

wherein in the balance information acquisition step, when acquiring the customer identification information, the balance information associated with the customer identification information is acquired from the electronic-value storage unit.

11-4. The settlement method according to any one of 11 to 11-3,

wherein in the settlement step, a process of adding an amount reduced from the electronic value of a customer to the electronic value of a store is further executed as the settlement process.

11-5. The settlement method according to 11-4,

wherein in the settlement step, content of the use information of the electronic value is changed, when the electronic value of the customer is transferred to the electronic value of the store.

11-6. The settlement method according to any one of 11 to 11-5,

wherein in the settlement information acquisition step, the use information which is set in advance for each store is acquired as the settlement information.

11-7. The settlement method according to any one of 11 to 11-5,

wherein in the settlement information acquisition step, the use information which is set in advance for a product to be settled for is acquired as the settlement information.

11-8. The settlement method according to any one of 11 to 11-7,

wherein the electronic-value storage unit further stores an expiration date of the electronic value, as the balance information, and

wherein in the settlement step, the settlement process is executed using the electronic value of which the expiration date has not passed.

11-9. The settlement method according to any one of 11 to 11-8,

wherein in the balance information acquisition step, a plurality of pairs each having the balance of the electronic value and the use information is acquired, and

wherein in the settlement step, in a case where there are a plurality of pairs satisfying the predetermined condition, the electronic value to be used for the settlement process is determined based on a priority which is set in advance.

12. A program causing a computer to function as:

a balance information acquisition unit that acquires balance information including balance of an electronic value and use information of the electronic value from an electronic-value storage unit that stores the balance information;

a settlement information acquisition unit that acquires settlement information including an increase or decrease value of the electronic value and the use information; and

a settlement unit that executes a settlement process of increasing or decreasing the electronic value stored in the electronic-value storage unit, in a case where the use information included in the balance information and the use information included in the settlement information satisfy a predetermined condition which is set in advance.

12-2. The program according to 12,

wherein the balance information acquisition unit receives the balance information, from a portable storage apparatus including the electronic-value storage unit.

12-3. The program according to 12-2,

wherein a server includes the electronic-value storage unit, and the balance information stored in the electronic-value storage unit is associated with customer identification information, and

wherein when acquiring the customer identification information, the balance information acquisition unit acquires the balance information associated with the customer identification information from the electronic-value storage unit.

12-4. The program according to any one of 12 to 12-3,

wherein the settlement unit further executes a process of adding an amount reduced from the electronic value of a customer to the electronic value of a store, as the settlement process.

12-5. The program according to 12-4,

wherein the settlement unit changes content of the use information of the electronic value when the electronic value of the customer is transferred to the electronic value of the store.

12-6. The program according to any one of 12 to 12-5,

wherein the settlement information acquisition unit acquires the use information which is set in advance for each store, as the settlement information.

12-7. The program according to any one of 12 to 12-5,

wherein the settlement information acquisition unit acquires the use information which is set in advance for a product to be settled for, as the settlement information.

12-8. The program according to any one of 12 to 12-7,

wherein the electronic-value storage unit further stores an expiration date of the electronic value, as the balance information, and

wherein the settlement unit performs the settlement process using the electronic value of which the expiration date has not passed.

12-9. The program according to any one of 12 to 12-8,

wherein the balance information acquisition unit acquires a plurality of pairs each having the balance of the electronic value and the use information, and

wherein in a case where there are a plurality of pairs satisfying the predetermined condition, the settlement unit determines the electronic value to be used for the settlement process, based on a priority which is set in advance.

This application claims priority based on Japanese Patent Application No. 2016-046519 filed on Mar. 10, 2016, and the disclosure of which is incorporated herein in its entirety.

1. A settlement apparatus comprising:
at least one memory configured to store one or more instructions; and
at least one processor configured to execute the one or more instructions to:
acquire balance information including a balance of an electronic value and use information of the electronic value;
acquire settlement information including an increase or decrease value of the electronic value and the use information; and
execute a settlement process of increasing or decreasing the electronic value, in a case where the use information included in the balance information and the use information included in the settlement information satisfy a predetermined condition which is set in advance.

2. The settlement apparatus according to claim 1,
wherein the at least one processor is configured to receive the balance information, from a portable storage apparatus.

3. The settlement apparatus according to claim 2,
wherein the balance information stored in a server is associated with customer identification information, and
wherein the at least one processor is configured to acquire the balance information associated with the acquired customer identification information when acquiring the customer identification information.

4. The settlement apparatus according to claim 1,
wherein the settlement unit further executes a process of adding an amount reduced from the electronic value of a customer to the electronic value of a store, as the settlement process.

5. The settlement apparatus according to claim 4,
wherein the at least one processor is configured to change content of the use information of the electronic value when the electronic value of the customer is transferred to the electronic value of the store.

6. The settlement apparatus according to claim 1,
wherein the at least one processor is configured to:
acquire the use information which is set in advance for each store, as the settlement information.

7. The settlement apparatus according to claim 1,
wherein the at least one processor is configured to acquire the use information which is set in advance for a product to be settled for, as the settlement information.

8. The settlement apparatus according to claim 1,
wherein the at least one processor is configured to perform the settlement process using the electronic value of which an expiration date of the electronic value has not passed.

9. The settlement apparatus according to claim 1,
wherein the at least one processor is configured to:
acquire a plurality of pairs each having the balance of the electronic value and the use information, and
determine the electronic value to be used for the settlement process, based on a priority which is set in advance in a case where there are a plurality of pairs satisfying the predetermined condition.

10. A settlement system comprising:
a storage apparatus stores balance information including a balance of an electronic value and use information of the electronic value; and
the settlement apparatus according to claim 1.

11. A settlement method performed by a computer, the method comprising:
acquiring balance information including a balance of an electronic value and use information of the electronic value;
acquiring settlement information including an increase or decrease value of the electronic value and the use information; and
executing a settlement process of increasing or decreasing the electronic value, in a case where the use information included in the balance information and the use information included in the settlement information satisfy a predetermined condition which is set in advance.

12. A non-transitory storage medium storing a program causing a computer to:
acquire balance information including a balance of an electronic value and use information of the electronic value;
acquire settlement information including an increase or decrease value of the electronic value and the use information; and
execute a settlement process of increasing or decreasing the electronic value, in a case where the use information included in the balance information and the use information included in the settlement information satisfy a predetermined condition which is set in advance.

13. The settlement apparatus according to claim 2,
wherein the at least one processor is configured to execute a process of adding an amount reduced from the electronic value of a customer to the electronic value of a store, as the settlement process.

14. The settlement apparatus according to claim 3,
wherein the at least one processor is configured to execute a process of adding an amount reduced from the electronic value of a customer to the electronic value of a store, as the settlement process.

15. The settlement apparatus according to claim 2,
wherein the at least one processor is configured to acquire the use information which is set in advance for each store, as the settlement information.

16. The settlement apparatus according to claim 3,
wherein the at least one processor is configured to acquire the use information which is set in advance for each store, as the settlement information.

17. The settlement apparatus according to claim 4,
wherein the at least one processor is configured to acquire the use information which is set in advance for each store, as the settlement information.

18. The settlement apparatus according to claim 2,
Wherein the at least one processor is configured to acquire the use information which is set in advance for a product to be settled for, as the settlement information.

19. The settlement apparatus according to claim 3,
Wherein the at least one processor is configured to acquire the use information which is set in advance for a product to be settled for, as the settlement information.

20. The settlement apparatus according to claim 4,
Wherein the at least one processor is configured to acquire the use information which is set in advance for a product to be settled for, as the settlement information.
